(19) United States
(12) Patent Application Publication
(10) Pub. No.: US 2013/0298067 A1
(43) Pub. Date: Nov. 7, 2013

(54) Thumbmarking in an E-Book Reader with Multitouch

(71) Applicants: Evan PARKER, Atherton, CA (US); Neal Kanodia, Mountain View, CA (US)

(72) Inventors: Evan PARKER, Atherton, CA (US); Neal Kanodia, Mountain View, CA (US)

(73) Assignee: Google Inc., Mountain View, CA (US)

(21) Appl. No.: 13/177,299

(22) Filed: Jul. 6, 2011

(51) Int. Cl. G06F 3/048

(52) U.S. Cl. 715/776

(57) ABSTRACT

Embodiments disclosed relate to navigation through pages of an electronic book. A user may wish to bookmark a particular page of a book using her thumb to quickly reference a page. After bookmarking a page, the user may navigate to other pages of the electronic book. Using a tilt gesture or swipe gesture, the user may quickly return to the bookmarked page.

### BACKGROUND

1. Field

Embodiments relate to bookmarking pages in electronic book readers.

2. Background

Bookmarking pages in electronic books displayed on electronic book readers may currently be accomplished by a menu option or other functionality provided by the electronic book reader. For example, a menu option may allow a user to specify a page to be bookmarked. The menu option may further allow the user to return to the bookmark by accessing the menu option.

### BRIEF SUMMARY

A method, system and computer program product of navigating in an electronic book is disclosed. A page of the electronic book is displayed. A persistent touch input from a user, indicating that the user wishes to bookmark the currently displayed page, is detected. An input from the user is detected indicating that the user wishes to navigate through pages of the electronic book, while the persistent touch input is detected. A further input is detected indicating that the user wishes to return to the desired bookmark. Upon detection of the input, the bookmarked page is displayed.

A second persistent touch input may be detected, indicating a second desired bookmark. An input may be detected that indicates the user wishes to return to the first desired bookmark. The first desired bookmarked page may be displayed. A further input may be detected that indicates the user wishes to return to the second desired bookmark. The second desired bookmarked page may be displayed.

Further embodiments, features, and advantages of the invention, as well as the structure and operation of the various embodiments of the invention are described in detail below with reference to accompanying drawings.

### BRIEF DESCRIPTION OF THE DRAWINGS/FIGURES

Embodiments of the invention are described with reference to the accompanying drawings. In the drawings, like reference numbers may indicate identical or functionally similar elements. The drawing in which an element first appears is generally indicated by the left-most digit in the corresponding reference number.

FIGS. 1A-1D are exemplary diagrams showing an electronic book reader in accordance with embodiments.

FIG. 2 is a flow diagram of a method of navigating in an electronic book, in accordance with embodiments.

FIG. 3 is a flow diagram of a further method of navigating in an electronic book, in accordance with embodiments.

FIG. 4 is a diagram of an exemplary electronic book navigation system.

FIG. 5 is a diagram of a system that may be used to implement embodiments disclosed herein.

### DETAILED DESCRIPTION

While the present invention is described herein with reference to the illustrative embodiments for particular applications, it should be understood that the invention is not limited thereto. Those skilled in the art with access to the teachings provided herein will recognize additional modifications, applications, and embodiments within the scope thereof and additional fields in which the invention would be of significant utility.

In the detailed description of embodiments that follows, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Although existing electronic book readers may allow bookmarking of pages in electronic books by menu options or placing indicators (such as stars) on a desired bookmarked page, such menu options and other methods do not correspond to bookmarking actions performed on traditional paper books. For example, a reader may use her thumb to keep her place in a traditional book. As an example, when using a paper travel guide in a tourist destination, a book reader may keep her thumb on a frequently referenced page, such as a map, and turn to and read other pages to determine interesting destinations the book reader wishes to visit. By holding her thumb on the map page, she can easily flip back to the map page to determine where on the map the destination is.

In a further example, a reference book may have one or more pages of endnotes placed at the end of the book that assist a reader in understanding concepts throughout the book. A book reader may keep her place in the endnote pages using her thumb, such that when she reads text related to an unfamiliar concept, she can quickly refer to the endnote pages. Further, when she turns to the endnote pages, she may keep her other thumb on the page she is currently reading, so that when she is done reading the particular endnote, she can quickly return to her reading place.

Certain electronic book readers are equipped with display devices that can detect multiple touch inputs simultaneously. Such display devices are known as multitouch devices. Multitouch devices may further be equipped to detect persistent touch inputs.

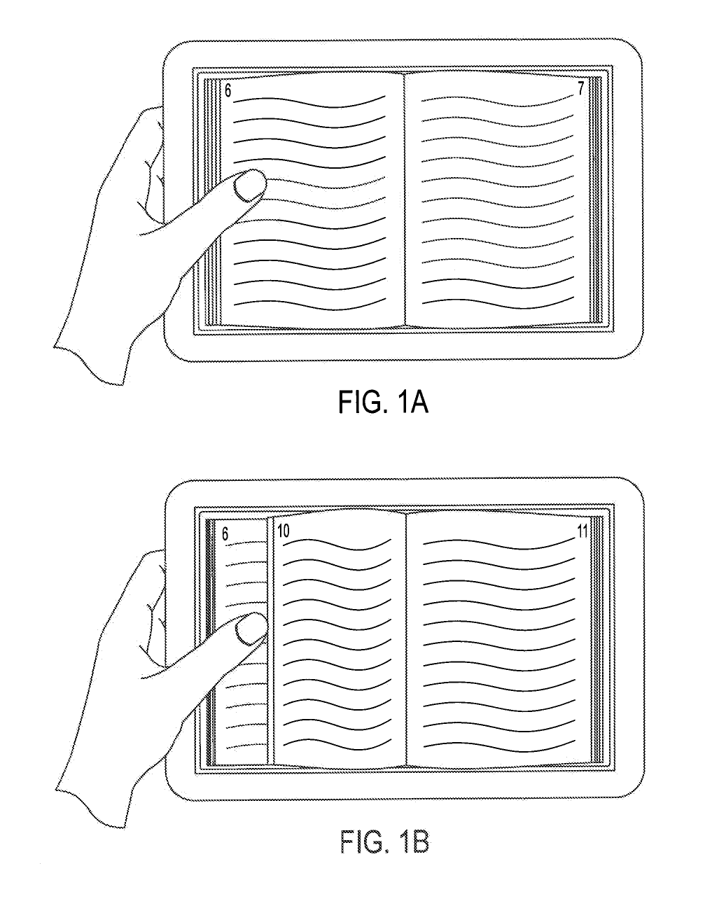

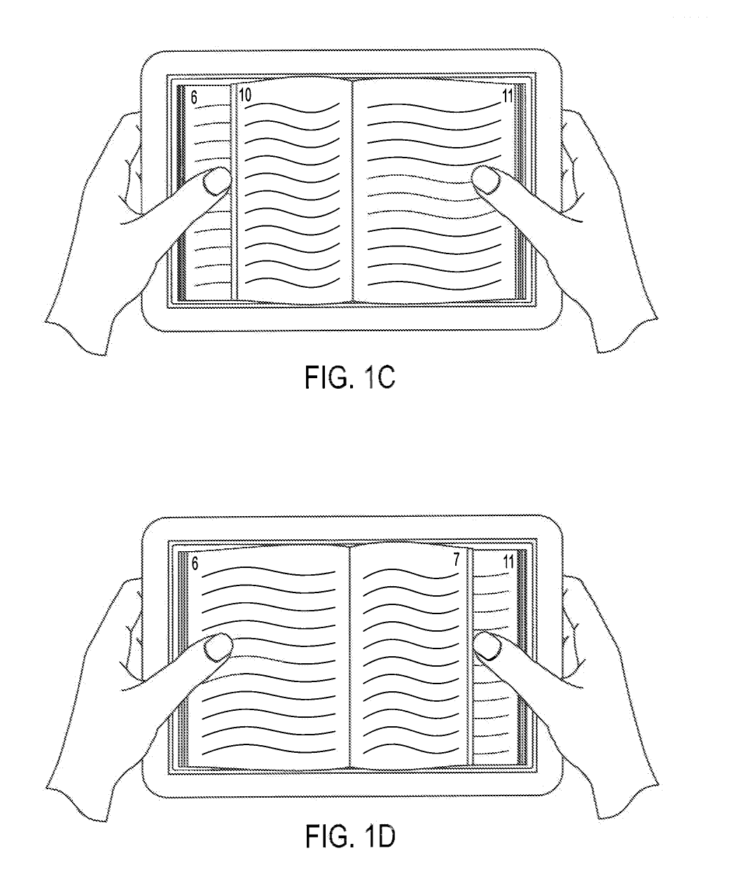

FIGS. 1A-1D are representations of an electronic book reader having a display that may be used to implement embodiments disclosed herein. Although FIGS. 1A-1D are described with reference to an electronic book reader, embodiments disclosed herein are not intended to be limited to implementation on an electronic book reader or any specific device. In FIG. 1A, pages 6 and 7 of a particular electronic book are displayed on the electronic book reader. A user may place her thumb in contact with the display on page 6 to indicate that she wishes to bookmark or frequently reference page 6.

FIG. 1B is a representation of an electronic book reader display after the user has navigated to further pages of the electronic book. In the example of FIG. 1B, the user has navigated to pages 10 and 11. For example, while the user maintained the touch contact with the display on page 6, the user may also have provided some additional indication, such as a separate swipe gesture or a selection of a navigation button, that results in navigation through the electronic book. Because the user has bookmarked page 6, which is on the left side of the electronic book, pages 8 and 10 appear as if they have piled on top of page 6 against the user's thumb after navigation of the book to page 10.

FIG. 1C is a representation of an electronic book reader display similar to that of FIG. 1B. In FIG. 1C, the user may wish to frequently reference a different page of the electronic book, in this case, page 11, in addition to the originally referenced page (page 6 in this example). The user may place her second thumb on page 11 to indicate that she wishes to bookmark page 11 in addition to page 6.

FIG. 1D is a further representation of an electronic book reader display. In FIG. 1D, the user may have wished to return to the bookmarked page 6, and provided some indication to the electronic book reader that navigation was desired, as will be described in further detail below. In this example, because the user placed her thumb on page 11 to indicate that she wished to bookmark page 11, pages 7 and 9 appear as if they have piled on top of page 11 against the user's thumb.

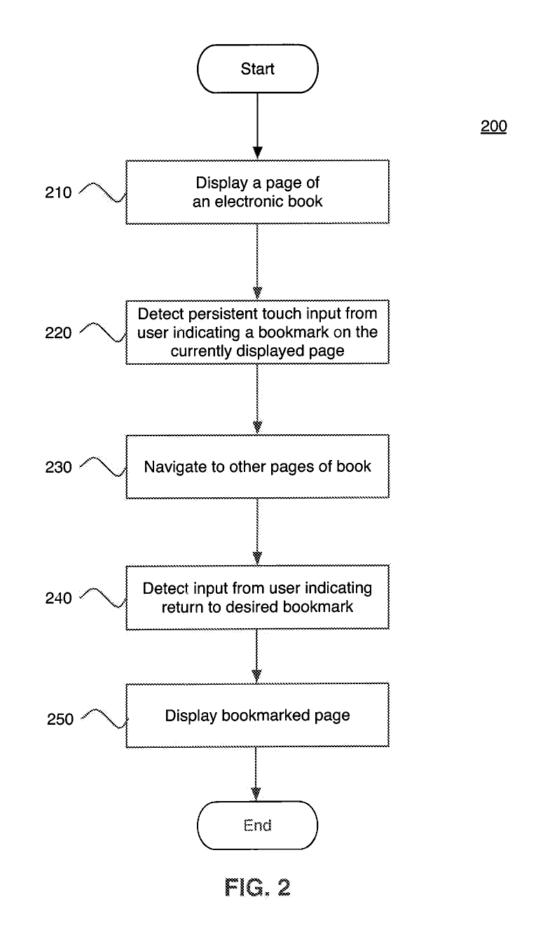

Emulating the act of bookmarking a page that is frequently referenced by a thumb may be desired by a user of an electronic book reader who is currently using the electronic book reader to read a travel guide, reference book, or any other type of book. FIG. 2 is a diagram of such a method 200 for navigating in an electronic book reader.

At block 210, a page of an electronic book is displayed. Depending on the electronic book reader implementing method 200, one or more pages may be displayed. For example, as in FIG. 1A, two pages of the electronic book may be displayed.

At block 220, a persistent touch input from a user indicating a desired bookmark on the currently displayed page is detected. The persistent touch input may be detected by a multitouch display device which is a component of an electronic book reader. Additionally, the persistent touch input may be detected as a result of a user placing and holding her thumb on the multitouch display device, as in FIG. 1A.

At block 230, a user may navigate to other pages of the electronic book while maintaining the persistent touch input. An input may be detected that signals that the user wishes to navigate to other pages of the electronic book. Depending on the electronic book reader and software or other instructions used to implement the electronic book reader, navigating to other pages of the electronic book may be accomplished in a number of ways. For example, the user may make a swipe motion with her finger. Additionally, certain electronic book readers may employ a scroll wheel, optical trackpad or trackball, or other navigation methods, to turn to other pages in the book.

At block 240, an input from the user indicating that the user wishes to return to the desired bookmark is detected. For example, in an electronic book reader having a multitouch display device, the user may make a flicking type motion with the finger applying the persistent touch input. Using the example of FIG. 1B, the user may quickly move her thumb to the right, to appear as if she is swiftly moving the piled up pages away to view the bookmarked page. Further, in an electronic book reader equipped with a gyroscope or tilt sensor, the user may tilt or shake her device to indicate that she wishes to return to the bookmarked page. That is, when the user is ready to navigate back to a bookmarked page, the user may tilt the electronic book reader in a manner that, in a regular book, would cause the pages to flip back to the bookmarked page. The electronic book reader may then interpret the tilting as an input instructing the electronic book reader to navigate to the bookmarked page. This input may be detected in accordance with block 240.

At block 250 then, in response to the detected input, the bookmarked page is displayed. For example, the display of the electronic book reader may appear as in FIG. 1A, where pages 6 and 7 are displayed.

In an embodiment, in response to the input received at block 230 that the user wishes to navigate to other pages of the electronic book, the display of the electronic book reader may appear as in FIG. 1B. For example, if the user wishes to bookmark page 6, and navigate to page 10, pages in between may appear to pile against the user's thumb.

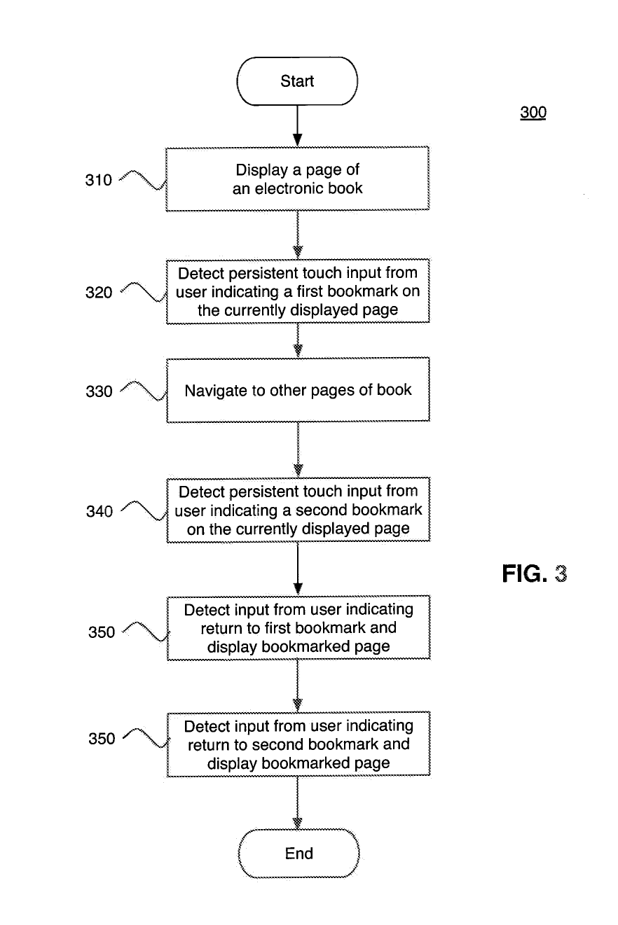

FIG. 3 is a flowchart of a further method 300 for navigating an electronic book in an electronic book reader.

At block 310, a page of an electronic book is displayed. Depending on the particular electronic book reader or device implementing method 300, one or more pages may be displayed. For example, as in FIG. 1A, two pages of the electronic book may be displayed.

At block 320, a first persistent touch input from a user, indicating a first bookmark on a currently displayed page, is detected. For example, as in FIG. 1A, a user may place and hold her thumb on a currently displayed page to indicate that she wishes to bookmark that page. The persistent touch input may be detected by the multitouch display device.

At block 330, the user may navigate to other pages of the electronic book. The navigation may be as a result of a detection of a farther input. For example, the user may make a separate swipe gesture on the multitouch display device to indicate that she wishes to view other pages of the electronic book. In response, the electronic book reader display may appear as in FIG. 1B, where the user has navigated to pages 10 and 11 of the electronic book.

At block 340, a second persistent touch input, indicating a second bookmark on the currently displayed page, is detected. For example, as in FIG. 1C, a user may place and hold her thumb on a second page that she wishes to frequently reference. In FIG. 1C, the user places her thumb on page 11.

At block 350, an input from the user indicating a desired return to the first bookmarked page is detected. For example, as described with respect to block 240 of method 200, the user may tilt her device or make a flicking type motion to indicate that she wishes to retain to the first bookmarked page. In the example of tilting a device, if the first bookmarked page is displayed on the left side of the device, the user may tilt the left side of her device upwards. As a result of the detected input, the first bookmarked page is displayed, as in FIG. 1D.

At block 360, an input from the user indicating a return to the second bookmarked page is detected. As described with respect to block 350 and block 240, the user may make a tilt motion or a flicking type motion to indicate that she wishes to return to the second bookmarked page. For example, if the second bookmarked page is displayed on the right side of the device, the user may tilt the right side of her device upwards. As a result, the second bookmarked page is displayed. The display of the electronic book reader may appear as in FIG. 1C. Although the first and second bookmarks are described herein as being on the left and right of the electronic book reader display, respectively, the bookmarks are not limited in this way, and may be located in any other position that appropriately identifies the page(s) to be bookmarked.

In an embodiment, if a persistent touch input is no longer detected, pages of an electronic book that appear to be piled against a finger or thumb as in FIGS. 1B-1D may appear to fall against the edge of the display such that they are no longer bookmarked. For example, in FIG. 1D, pages 7 and 9 of an electronic book appear to be piled up against a user's right thumb, which is currently bookmarking page 11 of the electronic book. if the user lifts her thumb from the right side of the electronic book reader, pages 7 and 9 may no longer be piled up against her thumb, and may shift to the right, such that the electronic book displays pages 6 and 7 as in FIG. 1A.

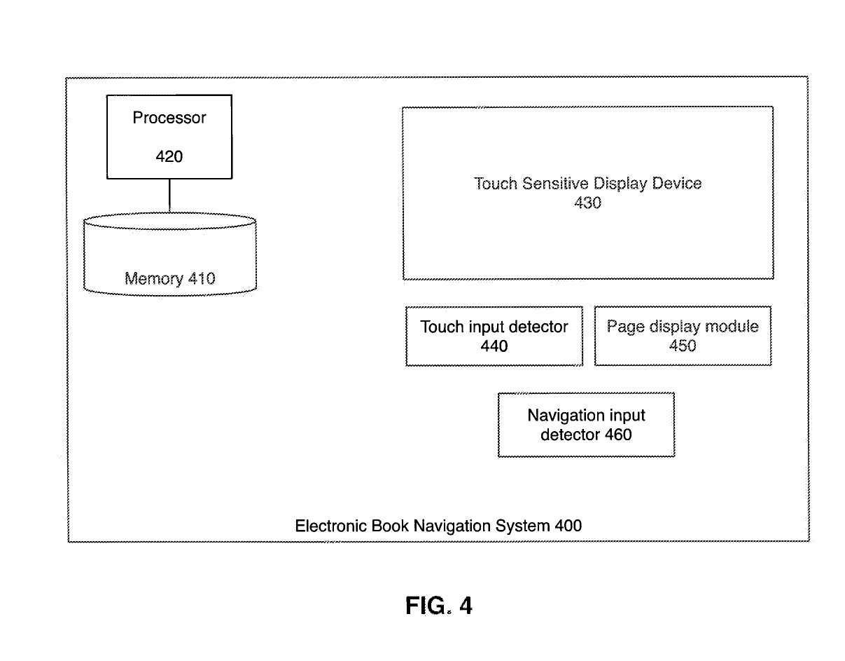

FIG. 4 is a diagram of an exemplary electronic book navigation system 400 that may be used to implement embodiments disclosed herein. Electronic book navigation system 400 may be implemented on a computing device, such as a mobile telephone, tablet computer, laptop computer, electronic book reader, game console, or other such computing device.

Electronic book navigation system 400 includes a memory 410 and a processor 420. Memory 410 may store instructions to implement the various method steps described herein, as well as one or more electronic books for display by the electronic book reader. Processor 420, connected to memory 410, may execute the instructions stored by memory 410 to cause the electronic book navigation system 400 or device implementing the system to execute the method steps disclosed herein.

Electronic book navigation system 400 further includes a touch sensitive display device 430. Touch sensitive display device 430 may be configured to detect multiple touch inputs simultaneously. Such devices may be known as multitouch displays.

Electronic book navigation system 400 also includes a touch input detector 440. Touch input detector 440 may operate in conjunction with touch sensitive display device 430 to detect persistent touch inputs in accordance with embodiments disclosed herein.

Electronic book navigation system 400 also includes page display module 450. Page display module 450 may be configured to display one or more pages on touch sensitive display device 430, in accordance with embodiments disclosed herein.

Electronic book navigation system 400 also includes navigation input detector 460. Navigation input detector 460 may detect an input from a user, such as a scroll wheel movement or optical trackpad movement, that indicates that the user wishes to navigate through pages of an electronic book. Further, touch input detector 440 may be configured to detect a touch input from a user indicating navigation to desired pages in an electronic book in conjunction with navigation input detector 460.

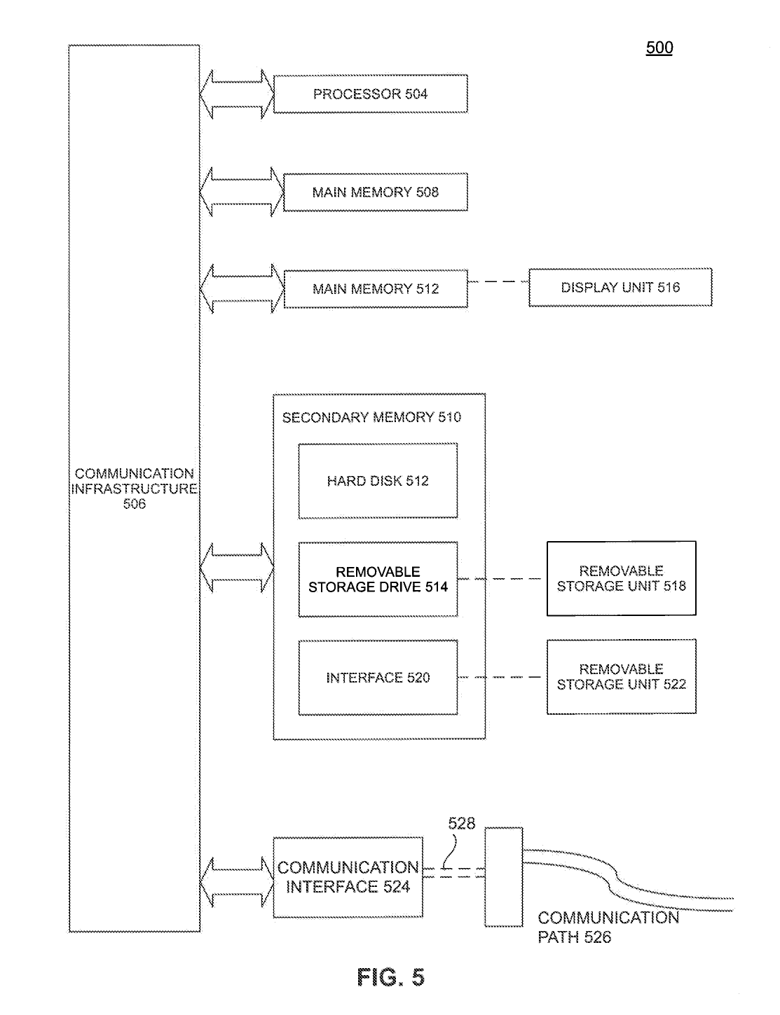

Various aspects of the present invention can be implemented by software, firmware, hardware, or a combination thereof. FIG. 5 illustrates an example computer system 500 in which the embodiments, or portions thereof, can be implemented as computer-readable code. For example, electronic book navigation system 400 carrying out method 200 of FIG. 2 or method 300 of FIG. 3 can be implemented in system 500. Various embodiments of the invention are described in terms of this example computer system 500.

Computer system 500 includes one or more processors, such as processor 504. Processor can be a special purpose or a general purpose processor. Processor 504 is connected to a communication infrastructure 506 (for example, a bus or network).

Computer system 500 also includes a main memory 508, preferably random access memory (RAM), and may also include a secondary memory 510. Secondary memory 510 may include, for example, a hard disk drive and/or a removable storage drive. Removable storage drive 514 may include a floppy disk drive, a magnetic tape drive, an optical disk drive, a flash memory, or the like. The removable storage drive 514 reads from and/or writes to removable storage unit 518 in a well known manner. Removable storage unit 518 may include a floppy disk, magnetic tape, optical disk, etc. which is read by and written to by removable storage drive 514. As will be appreciated by persons skilled in the relevant art(s), removable storage unit 518 includes a computer usable storage medium having stored therein computer software and/or data.

In alternative implementations, secondary memory 510 may include other similar means for allowing computer programs or other instructions to be loaded into computer system 500. Such means may include, for example, a removable storage unit 522 and an interface 520. Examples of such means may include a program cartridge and cartridge interface (such as that found in video game devices), a removable memory chip (such as an EPROM, or PROM) and associated socket, and other removable storage units 522 and interfaces 520 which allow software and data to be transferred from the removable storage unit 522 to computer system 500.

Computer system 500 may also include a communications interface 524. Communications interface 524 allows software and data to be transferred between computer system 500 and external devices. Communications interface 524 may include a modem, a network interface (such as an Ethernet card), a communications port, a PCMCIA slot and card, or the like. Software and data transferred via communications interface 524 are in the form of signals which may be electronic, electromagnetic, optical, or other signals capable of being received by communications interface 524. These signals are provided to communications interface 524 via a communications path 526. Communications path 526 carries signals and may be implemented using wire or cable, fiber optics, a phone line, a cellular phone link, an RF link or other communications channels.

In this document, the term “computer readable storage medium” is used to generally refer to media such as removable storage unit 518, removable storage unit 522, and a hard disk installed in hard disk drive 512. Computer readable storage medium can also refer to one or more memories, such as main memory 508 and secondary memory 510, which can be memory semiconductors (e.g. DRAMs, etc.). These computer program products are means for providing software to computer system 500.

Computer programs (also called computer control logic) are stored in main memory 508 and/or secondary memory 510. Computer programs may also be received via communications interface 524. Such computer programs, when executed, enable computer system 500 to implement the embodiments as discussed herein. In particular, the computer programs, when executed, enable processor 504 to implement the processes of embodiments of the present invention, such as the steps in the methods discussed above. Accordingly, such computer programs represent controllers of the computer system 500. Where embodiments are implemented using software, the software may be stored in a computer program product and loaded into computer system 500 using removable storage drive 514, interface 520, or hard drive 512.

Embodiments may be directed to computer products comprising software stored on any computer usable medium. Such software, when executed in one or more data processing device, causes a data processing device(s) to operate as described herein.

Embodiments may be implemented in hardware, software, firmware, or a combination thereof. Embodiments may be implemented via a set of programs running in parallel on multiple machines.

The summary and abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments.

What is claimed is:

1. A computer-implemented method of navigating in an electronic book, comprising:
displaying a page of the electronic book;
detecting a. first persistent touch input from a user indicating a desired bookmark on a first displayed page in the electronic book;
detecting an input from the user indicating navigation during the detection of the first persistent touch input;
detecting an input from the user indicating a return to the desired bookmark; and
displaying the bookmarked page.

2. The method of claim 1, wherein the desired bookmark is a first desired bookmark and the bookmarked page is a first bookmarked page; and further comprising:
detecting a second persistent touch input from the user indicating a second desired bookmark on a second displayed page in the electronic book.

3. The method of claim 2, further comprising:
detecting an input from the user indicating a return to the second desired bookmark; and
displaying the second bookmarked page.

4. The method of claim 1, wherein the input from the user indicating the return to the desired bookmark is a swipe gesture.

5. The method of claim 1, wherein the input from the user indicating the return to the desired bookmark is received as a result of detecting a tilt motion.

6. A system for navigating in an electronic book, comprising:
a touch sensitive display device;
one or more processors; and
a memory in communication with the one or more processors, the memory containing instructions that cause the processor to:
display a page of the electronic book on the touch sensitive display device,
detect a first persistent touch input from a user indicating a desired bookmark on a first displayed page in the electronic book,
detect an input from the user indicating navigation during the detection of the first persistent touch input,
detect an input from the user indicating return to the desired bookmark, and
display the bookmarked page.

7. The system of claim 6, wherein the desired bookmark is a first desired bookmark, the memory further containing instructions that cause the processor to:
detect a second persistent touch input from a user indicating a second desired bookmark on a second displayed page in the electronic book;

8. The system of claim 7, the memory further containing instructions that cause the processor to detect an input from the user indicating return to the second desired bookmark and display the second bookmarked page.

9. The system of claim 6, wherein the input from the user indicating return to the desired bookmark is a swipe gesture.

10. The system of claim 6, wherein the input from the user indicating return to the desired bookmark is received as a result of detecting a tilt motion.

11. A computer readable storage medium containing control logic stored thereon that, when executed by one or more processing devices, causes the one or more processing devices to execute a method of navigating in an electronic book, the control logic comprising:
a first computer readable program code that displays a page of the electronic book;
a second computer readable program code that detects a first persistent touch input from a user indicating a desired bookmark on a first displayed page of the electronic book;
a third computer readable program code that detects an input from the user indicating navigation during the detection of the first persistent touch input;
a fourth computer readable program code that detects an input from the user indicating a return to the desired bookmark; and
a fifth computer readable program code that displays the bookmarked page.

12. The computer readable storage medium of claim 11, wherein the desired bookmark is a first desired bookmark, and the bookmarked page is a first bookmarked page, and further comprising:
a sixth computer readable program code that detects a second persistent touch input from a user indicating a desired bookmark on a second displayed page in the electronic book.

13. The computer readable storage medium of claim 12, further comprising:
a seventh computer readable program code that detects an input from a user indicating return to the second desired bookmark; and
an eighth computer readable program code that displays the second bookmarked page.

14. The computer readable storage medium of claim 11, wherein the input from a user indicating return to the desired bookmark is a swipe gesture.

15. The computer readable storage medium of claim 11, wherein the input from a user indicating return to the desired bookmark is received as a result of detecting a tilt motion.
